(19) United States
(12) Patent Application Publication
(10) Pub. No.: US 2016/0363730 A1
(43) Pub. Date: Dec. 15, 2016

(54) FIBER FUSION SPLICE STRENGTH ENHANCEMENT

(71) Applicant: AFL TELECOMMUNICATIONS LLC, Duncan, SC (US)

(72) Inventor: Michael E. HARJU, Dorr, MI (US)

(73) Assignee: AFL Telecommunications LLC, Duncan, SC (US)

(21) Appl. No.: 14/783,571

(22) PCT Filed: Mar. 6, 2015
(86) PCT No.: PCT/US15/19222

§ 371 Date: Oct. 9, 2015

Related U.S. Application Data
(60) Provisional application No. 61/948,967, filed on Mar. 6, 2014.

(51) Int. Cl. G02B 6/255

(52) U.S. Cl. CPC G02B 6/2558

(57) ABSTRACT

An enhanced optical fiber fusion splice with a first optical fiber spliced to a second optical fiber; a strength enhancer surrounding the first fiber, the second fiber and the splice; wherein the first fiber has a melting point of less than approximately 1000 degrees C.

### CROSS-REFERENCE TO RELATED APPLICATIONS

This application is based upon and claims the benefit of priority from U.S. Provisional Application No. 61/948,967, filed Mar. 6, 2014 in the United States Patent and Trademark Office, the disclosures of which are incorporated herein in its entirety by reference.

### BACKGROUND

1. Field

The invention is related to an enhanced optical fiber fusion splice.

2. Related Art

The background information provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

Low melting point fibers, such as ZBLAN—250 C, Chalcogeinde—200 to 700 degrees C., etc., when spliced to themselves or to other higher melting point fibers, such as Silica based—1800 degrees C., etc., may have a very low splice strength. The splice strength can be less than 25 Kpsi. Thus, it is an objective of this invention to improve the splice strength.

### SUMMARY

Exemplary implementations of the present invention address at least the above problems and/or disadvantages and other disadvantages not described above. Also, the present invention is not required to overcome the disadvantages described above, and an exemplary implementation of the present invention may not overcome any of the problems listed above.

According to an aspect of an exemplary embodiment, an enhanced optical fiber fusion splice includes a first optical fiber spliced to a second optical fiber; a strength enhancer surrounding the first fiber, the second fiber and the splice; wherein the first fiber has a melting point of less than approximately 1000 degrees C.

According to other exemplary embodiments the second fiber has a melting point of less than approximately 1000 degrees C.

According to other exemplary embodiments the second fiber has a melting point of greater than approximately 1500 degrees C.

According to other exemplary embodiments the strength enhancer is a UV cured adhesive.

According to other exemplary embodiments the first fiber has a melting point in a range of approximately 200 to 700 degrees C.

According to other exemplary embodiments the second fiber has a melting point in a range of approximately 200 to 700 degrees C.

According to other exemplary embodiments the second fiber has a melting point greater than or equal to approximately 1800 degrees C.

According to other exemplary embodiments the enhanced optical fiber fusion splice has a splice strength of the splice is greater than or equal to 65 Kpsi.

### BRIEF DESCRIPTION OF THE DRAWING

FIG. 1 illustrates an embodiment of an enhanced optical fiber fusion splice, according to an exemplary embodiment.

FIG. 2 is a photograph of an embodiment of an enhanced optical fiber fusion splice, according to an exemplary embodiment.

### DETAILED DESCRIPTION

The following detailed description is provided to assist the reader in gaining a comprehensive understanding of the apparatuses described herein. Various changes, modifications, and equivalents of the apparatuses described herein will suggest themselves to those of ordinary skill in the art. Descriptions of well-known functions and structures are omitted to enhance clarity and conciseness.

The terms used in the description are intended to describe embodiments only, and shall by no means be restrictive. Unless clearly used otherwise, expressions in a singular form include a meaning of a plural form. In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

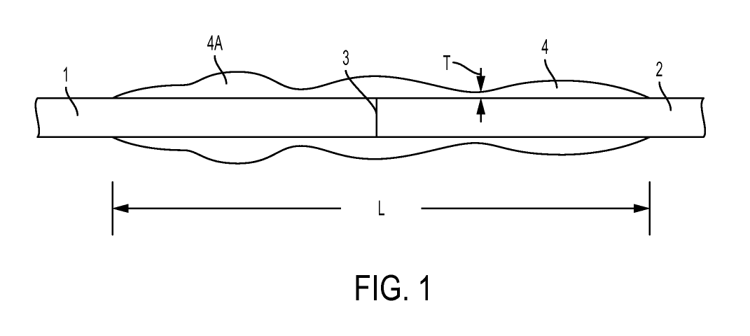

Referring to the drawings, FIG. 1 illustrates an embodiment of an enhanced optical fiber fusion splice, according to an exemplary embodiment. A unique aspect of this invention is the addition to a strength enhancer (in this case an overcoat) to a fusion splice (in this case a splice that may be highly stressed and weak) enabling additional post processing, such as cleaving.

In one embodiment shown in FIG. 1, a low melting point fiber 1, such as a 30 μm single mode (SM) silica fiber is spliced to a high melting point fiber 2, such as a 30 μm Borosilicate rod. The splice is shown as item 3. A strength enhancer 4 is then added to the area surrounding the splice 3. In this embodiment, the strength enhancer 4 is an over coat of UV cured adhesive DYMAX OP-4-20632. Other strength enhancers that can be used include, but are not limited to, UV cured epoxies. The thickness T of the strength enhancer should be in a range of approximately 5 to 50 μm. It should be noted that in a preferred embodiment, UV cured adhesives are used because they can be relatively easy to apply and they are a non-heat cure. Thus, they can increase the strength, while not affecting the optical properties of the fibers or the splice.

The strength enhancer 4 is added to a length L around the splice. In this embodiment, length L is approximately 500 μm. However, L is not limited to this length. For example, it may be longer if the splicing process damaged the fibers.

The strength enhancer 4 in this embodiment increased the splice strength to greater than 65 Kpsi.

Next, an example of a method used to create the enhanced optical fiber fusion splice will be described. First, fibers 1 and 2 were spliced with a conventional CO₂ laser based glass processing system, such as the AFL Telecommunications LZM-100.

Next, a strength enhancer 4 is applied is the area surrounding the splice 3. In one embodiment, a small diameter applicator, such as 30 μm fiber is dipped into a UV cured adhesive, such as DYMAX OP-4-20632. The applicator, with the adhesive 4 is then moved along the fibers, slowly transferring the adhesive 4 to the fibers 1, 2 around the splice 3. Depending the speed of application, and time before curing takes place, the adhesive 4 may form bulges 4A due to surface tension. It should be noted that it is not necessary for bulges to be formed. For example, several thin coats of adhesive could be applied and cured.

After the adhesive 4 is applied, it is cured, in this case with UV light.

In one embodiment, the method can be applied to two relatively low melting point fibers with melting points below approximately 1000 degrees C., such as ZBLAN=250 degrees C., Chalcogeinde—200 to 700 degrees C., etc. In another embodiment, one relatively low melting point fiber with a melting point below approximately 1000 degrees C., such as ZBLAN—250 degrees C., Chalcogeinde—200 to 700 degrees C., etc. is spliced to a relatively higher melting point fiber with a melting point greater than approximately 1500 degrees C., such as Silica based—1800 degrees C., etc.

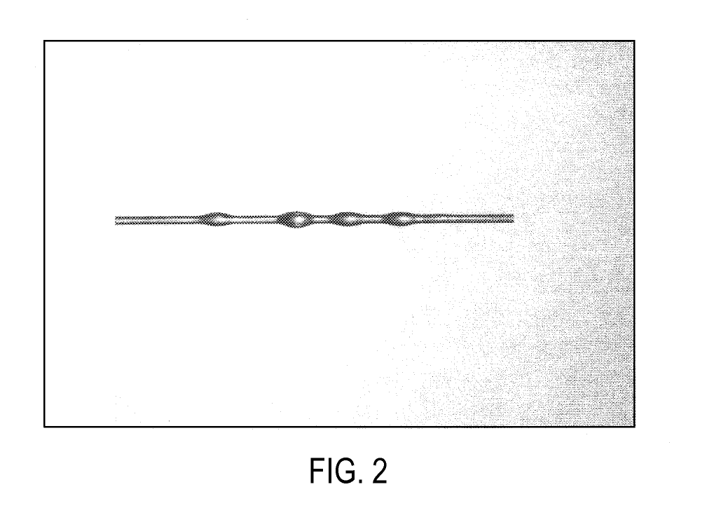

FIG. 2 is a photograph of an embodiment of an enhanced optical fiber fusion splice, according to an exemplary embodiment. In the photo, the splice is approximately around the area of the second bulge from the left and the second fiber on the right has been cleaved at the end.

As mentioned above, the embodiments described above are merely exemplary and the general inventive concept should not be limited thereto. While this specification contains many features, the features should not be construed as limitations on the scope of the disclosure or the appended claims. Certain features described in the context of separate embodiments can also be implemented in combination. Conversely, various features described in the context of a single embodiment can also be implemented in multiple embodiments separately or in any suitable sub-combination.

What is claimed is:

1. An enhanced optical fiber fusion splice comprising:
a first optical fiber spliced to a second optical fiber;
a strength enhancer surrounding the first fiber, the second fiber and the splice;
wherein the first fiber has a melting point of less than approximately 1000 degrees C.

2. The enhanced optical fiber fusion splice according to claim 1, wherein the second fiber has a melting point of less than approximately 1000 degrees C.

3. The enhanced optical fiber fusion splice according to claim 1, wherein the second fiber has a melting point of greater than approximately 1500 degrees C.

4. The enhanced optical fiber fusion splice according to claim 1, wherein the strength enhancer is a UV cured adhesive.

5. The enhanced optical fiber fusion splice according to claim 2, wherein the strength enhancer is a UV cured adhesive.

6. The enhanced optical fiber fusion splice according to claim 3, wherein the strength enhancer is a UV cured adhesive.

7. The enhanced optical fiber fusion splice according to claim 1, wherein the first fiber has a melting point in a range of approximately 200 to 700 degrees C.

8. The enhanced optical fiber fusion splice according to claim 1, wherein the second fiber has a melting point in a range of approximately 200 to 700 degrees C.

9. The enhanced optical fiber fusion splice according to claim 1, wherein the second fiber has a melting point greater than or equal to approximately 1800 degrees C.

10. The enhanced optical fiber fusion splice according to claim 9, wherein the first fiber has a melting point in a range of approximately 200 to 700 degrees C.

11. The enhanced optical fiber fusion splice according to claim 7, wherein the strength enhancer is a UV cured adhesive.

12. The enhanced optical fiber fusion splice according to claim 8, wherein the strength enhancer is a UV cured adhesive.

13. The enhanced optical fiber fusion splice according to claim 9, wherein the strength enhancer is a UV cured adhesive.

14. The enhanced optical fiber fusion splice according to claim 10, wherein the strength enhancer is a UV cured adhesive.

15. The enhanced optical fiber fusion splice according to claim 1, wherein a splice strength of the splice is greater than or equal to 65 Kpsi.

16. The enhanced optical fiber fusion splice according to claim 2, wherein a splice strength of the splice is greater than or equal to 65 Kpsi.

17. The enhanced optical fiber fusion splice according to claim 3, wherein a splice strength of the splice is greater than or equal to 65 Kpsi.

18. The enhanced optical fiber fusion splice according to claim 4, wherein a splice strength of the splice is greater than or equal to 65 Kpsi.

19. The enhanced optical fiber fusion splice according to claim 5, wherein a splice strength of the splice is greater than or equal to 65 Kpsi.

20. The enhanced optical fiber fusion splice according to claim 6, wherein a splice strength of the splice is greater than or equal to 65 Kpsi.
